(19) United States
(12) Patent Application Publication
(10) Pub. No.: US 2008/0211127 A1
(43) Pub. Date: Sep. 4, 2008

(54) CONVEYER APPARATUS AND METHOD FOR MANUFACTURING HONEYCOMB STRUCTURE

(75) Inventors: Kazuya NARUSE, Courtenay (FR); Eiji Sumiya, Ibi-gun (JP); Kosei Tajima, Ibi-gun (JP)

Correspondence Address: DITTHAVONG MORI & STEINER, P.C., 918 Prince St., Alexandria, VA, 22314, US

(73) Assignee: IBIDEN CO., LTD., Ogaki (JP)

(21) Appl. No.: 11/951,949

(22) Filed: Dec. 6, 2007

Related U.S. Application Data
(63) Continuation of application No. PCT/JP2006/308353, filed on Apr. 20, 2006.

(51) Int. Cl. B29C 44/02; B65G 65/42

(52) U.S. Cl. 264/45.1; 264/48

(57) ABSTRACT

A conveyer apparatus including a conveyer portion having disposed therein a conveyer configured to convey a wet mixture. The conveyer is configured to convey the wet mixture such that a percentage of change in moisture content of the wet mixture from before conveyance of the wet mixture to after conveyance is about 3% or less.

### CROSS-REFERENCE TO RELATED APPLICATIONS

This application is a continuation application of PCT Application No. PCT/JP2006/308353, filed on Apr. 20, 2006, the contents of which are incorporated herein by reference in their entirety.

### BACKGROUND OF THE INVENTION

1. Field of the Invention

The present invention relates to a conveyer apparatus, and a method for manufacturing a honeycomb structure.

2. Discussion of the Background

Harm to the environment and the human body caused by particulates such as soot contained in exhaust gas discharged from the internal combustion engines of buses, trucks and other vehicles, construction equipment and the like has recently become a problem. For that reason, there have been currently proposed numerous kinds of honeycomb filters using honeycomb structures of porous ceramic as filters for capturing particulates contained in exhaust gas, thereby purifying the exhaust gas.

Conventionally, when manufacturing a honeycomb structure, first, for example, a ceramic powder, a binder, and a liquid dispersing medium and the like are mixed together to prepare a wet mixture. The wet mixture is then extrusion molded continuously by using a die, and the extrusion molded body is cut to a prescribed length to manufacture a rectangular pillar-shaped honeycomb molded body.

Next, the honeycomb molded body obtained above is dried using microwave drying or hot-air drying, and afterward, prescribed cells are sealed to achieve a sealed state of the cells in which either end of the cells are sealed by a plug material layer. After the sealed state has been achieved, degreasing and firing treatments are carried out, thus manufacturing a honeycomb fired body.

After this, a sealing material paste is applied onto side faces of the honeycomb fired body, and honeycomb fired bodies are adhered together to prepare an aggregate of honeycomb fired bodies in which a multitude of honeycomb fired bodies are bonded together by interposing a sealing material layer (an adhesive layer). Cutting is then carried out to obtain a ceramic block using a cutting machine or the like and cutting the obtained aggregate of honeycomb fired bodies into a prescribed form, such as cylindrical or cylindroid form and the like. Finally, sealing material paste is applied on the periphery of the ceramic block to form a sealing material layer (a coat layer), thus completing the manufacturing of the honeycomb structure.

In such a manufacturing method, after the wet mixture has been prepared, it is necessary to convey this wet mixture via a conveyer apparatus to an extrusion molding apparatus.

For instance, an example of a conveyer apparatus configured to convey a wet mixture is described in JP-A 2002-255353 and JP-A H05-131432. The contents of JP-A 2002-255353 and JP-A H05-131432 are incorporated herein by reference in their entirety.

### SUMMARY OF THE INVENTION

The present invention advantageously provides a conveyer apparatus that includes a conveyer portion having disposed therein a conveyer configured to convey a wet mixture, where the conveyer portion is configured to convey the wet mixture such that a percentage of change in moisture content of the wet mixture from a time before conveyance to a time after conveyance is about 3% or less.

It is preferable that the conveyer apparatus further includes a storage portion configured to temporarily store the wet mixture.

It is preferable that the storage portion has an openable and closable discharging port on a bottom face of the storage portion.

Also, it is preferable that the storage portion is disposed upstream from the conveyer portion in a conveyance path of the wet mixture.

It is preferable that the conveyer apparatus further includes a first storage portion configured to temporarily store the wet mixture; and a second storage portion configured to temporarily store the wet mixture, where the first storage portion and the second storage portion are disposed at opposite end sides of the conveyer, and that the conveyer is configured to change a conveyance direction of the wet mixture deposited thereion and where the conveyer is configured to deliver the wet mixture to one of the first storage portion and the second storage portion in a continuous or intermittent manner by changing the conveyance direction.

In the conveyer apparatus according to the present invention, it is preferable that the conveyer portion includes a casing, and a belt conveyer disposed inside of the casing.

It is preferable that a partition member configured to partition off an interior of the casing is disposed near an end portion of a downstream side of the belt conveyer.

In the conveyer apparatus according to the present invention, it is preferable that the belt conveyer includes a belt and rollers, and that the conveyer apparatus further includes a first storage portion configured to store the wet mixture; and a second storage portion configured to store the wet mixture, where the first storage portion and the second storage portion are disposed at opposite end sides of the conveyer, and where the belt conveyer is configured to deliver the wet mixture to one of the first storage portion and the second storage portion in a continuous or intermittent manner by a forward rotation or reverse rotation of the rollers.

In the conveyer apparatus according to the present invention, it is preferable that the conveyer is any of a chain conveyer, a pallet conveyer, a trolley conveyer, a flow conveyer, a flight conveyer, a disc conveyer, and a screw conveyer.

The present invention also advantageously provides a method for manufacturing a honeycomb structure including a honeycomb fired body, where the method includes: carrying out a conveyance for conveying a wet mixture containing wet mixed inorganic powders to an extrusion molding apparatus; preparing by extrusion molding a pillar-shaped honeycomb molded body with a multiplicity of cells placed in parallel with one another in a longitudinal direction with a cell wall therebetween; and firing the honeycomb molded body, where, during the carrying out of the conveyance, the wet mixture is conveyed by a conveyer apparatus including a conveyer portion having disposed therein a conveyer configured to convey the wet mixture, and where the conveyer portion is configured to convey the wet mixture such that a percentage of change in moisture content of the wet mixture from a time before conveyance to a time after conveyance is about 3% or less.

In the method for manufacturing a honeycomb structure according to the present invention, it is preferable that prior to the preparing of the honeycomb molded body, the wet mixture is temporarily stored in a storage portion of the conveyer apparatus.

In the method for manufacturing a honeycomb structure according to the present invention, it is preferable that the storage portion stores at least about 1.5 times and at most about 3 times by weight of the met mixture as a molding capability of the extrusion molding apparatus.

It is preferable that the wet mixture is temporarily stored in the storage portion for a time period of at least about 1 hour and at most about 10 hours.

It is preferable that the conveyer apparatus includes a first storage portion and a second storage portion where the first storage portion and the second storage portion are disposed at opposite end sides of the conveyer, and that the wet mixture deposited on the conveyer is stored by being conveyed to one of the first storage portion and the second storage portion in a continuous or intermittent manner by changing a conveyance direction of the conveyer.

It is preferable that the storage portion has an openable and closable discharging port on a bottom face of the storage portion.

Also, it is preferable that the storage portion is disposed upstream of the conveyer portion in a conveyance path of the wet mixture.

In the method for manufacturing a honeycomb structure, it is preferable that the conveyer portion configuring the conveyer apparatus includes a casing, and a belt conveyer disposed inside of the casing.

In the method for manufacturing a honeycomb structure according to the present invention, it is preferable that a partition member configured to partition off an interior of the casing is disposed near an end portion of a downstream side of the belt conveyer.

In the method for manufacturing a honeycomb structure according to the present invention, it is preferable that the conveyer apparatus includes a first storage portion and a second storage portion, where the first storage portion and the second storage portion are disposed at opposite end sides of the conveyer, and where the wet mixture deposited on the belt conveyer is stored by being conveyed to one of the first storage portion and the second storage portion in a continuous or intermittent manner by a forward rotation or reverse rotation of the rollers.

In the method for manufacturing a honeycomb structure according to the present invention, it is preferable that the moisture content of the wet mixture is at least about 10% by weight and at most about 20% by weight after conveyance.

In the method for manufacturing a honeycomb structure according to the present invention, it is preferable that the honeycomb structure is formed by a plurality of honeycomb fired bodies combined with one another by interposing a sealing material layer.

In the method for manufacturing a honeycomb structure according to the present invention, it is preferable that the honeycomb structure is formed by a single honeycomb fired body.

### BRIEF DESCRIPTION OF THE DRAWINGS

A more complete appreciation of the invention and many of the attendant advantages thereof will become readily apparent with reference to the following detailed description, particularly when considered in conjunction with the accompanying drawings, in which:

FIG. 1 is a cross-sectional view schematically showing an example of a conveyer apparatus according to one embodiment of the present invention;

FIG. 2 is a cross-sectional view schematically showing another example of a conveyer apparatus according to one embodiment of the present invention;

FIG. 3-1A is a plan view schematically showing an example of a conveyer constituting a conveyer apparatus according to one embodiment of the present invention, and FIG. 3-1B is a cross-sectional view of FIG. 3-1A;

FIG. 3-2A is a plan view schematically showing another example of a conveyer constituting a conveyer apparatus according to one embodiment of the present invention, and FIG. 3-2B is a cross-sectional view of FIG. 3-2A;

FIG. 4 is a perspective view schematically showing an example of a honeycomb structure;

FIG. 5A is a perspective view schematically showing a honeycomb fired body constituting a honeycomb structure, and FIG. 5B is a cross-sectional view taken along a plane extending longitudinally from line A-A in FIG. 5A;

FIG. 6 is a side view schematically showing an example of an extrusion molding apparatus used in the extrusion molding; and

FIG. 7 is a partial cross-sectional view schematically showing an area at which a measurement of the value of the pressure during extrusion molding is taken.

### DETAILED DESCRIPTION OF EMBODIMENTS OF THE INVENTION

Embodiments of the present invention will be described hereinafter with reference to the accompanying drawings. In the following description, the constituent elements having substantially the same function and arrangement are denoted by the same reference numerals, and repetitive descriptions will be made only when necessary.

Embodiments of the conveyer apparatus according to the present invention include a conveyer portion having disposed therein a conveyer configured to convey a wet mixture, where a percentage of change in moisture content of the wet mixture from before conveyance to after conveyance is about 3% or less.

Here, ‘a percentage of change in moisture content of the wet mixture from before conveyance to after conveyance is about 3% or less’ means an absolute value of the percentage of change in moisture content of the wet mixture between a time before and a time after conveyance is about 3% or less.

In the conveyer apparatus according to the embodiments of the present invention, it may become easier to prevent drying of the wet mixture during the conveyance, as well as to keep the percentage of change in moisture content of the wet mixture between before and after conveyance to about 3% or less. Because of this, it may become easier to supply wet mixture of a constant degree of quality to apparatuses used in the subsequent processes in a stable manner.

Also, in cases of using the conveyer apparatus according to the embodiments of the present invention as the conveyer apparatus used before the extrusion molding in the manufacturing of a honeycomb structure for example, because it may become easier to supply wet mixture having a suitable moisture content to the extrusion molding apparatus in a stable manner, it may become easier to prevent cracks, cell cut-off and the like from occurring in the extrusion molded body.

In particular, in the conveyer apparatus according to the embodiments of the present invention, when the partition member configured to partition the interior of the casing is used near the end portion of the downstream side of the belt conveyer constituting the conveyer apparatus, it may become easier to effectively prevent drying of the wet mixture inside of the conveyer apparatus, and further it may become easier to reduce the percentage of change in moisture content of the wet mixture between before and after conveyance.

Embodiments of a method for manufacturing a honeycomb structure including a honeycomb fired body according to the present invention include: carrying out a conveyance for conveying a wet mixture containing wet mixed inorganic powders to an extrusion molding apparatus; preparing by extrusion molding a pillar-shaped honeycomb molded body with a multiplicity of cells placed in parallel with one another in a longitudinal direction with a cell wall therebetween; and firing the honeycomb molded body, where, in the conveyance, the wet mixture is conveyed to an extrusion molding apparatus by a conveyer apparatus including a conveyer portion having disposed therein a conveyer configured to convey a wet mixture, where a percentage of change in moisture content of the wet mixture from before conveyance to after conveyance is about 3% or less.

In the method for manufacturing a honeycomb structure according to the embodiments of the present invention, since it may become easier to keep the percentage of change in moisture content of the wet mixture between before and after conveyance to about 3% or less, it may become easier to supply wet mixture having a suitable moisture content to the extrusion molding apparatus in a stable manner, and it may become easier to prevent cracks, cell cut-off and the like from occurring in the extrusion molded body.

Also, in the method for manufacturing a honeycomb structure according to the embodiments of the present invention, since the moisture content of the wet mixture after conveyance is at least about 10% by weight and at most about 20% by weight, it may become easier to attain an extrusion molded body that has no occurrence of cracks, cell cut-off or the like, and maintains a constant shape.

First, an explanation will be given in regard to the conveyer apparatus according to the embodiments of the present invention.

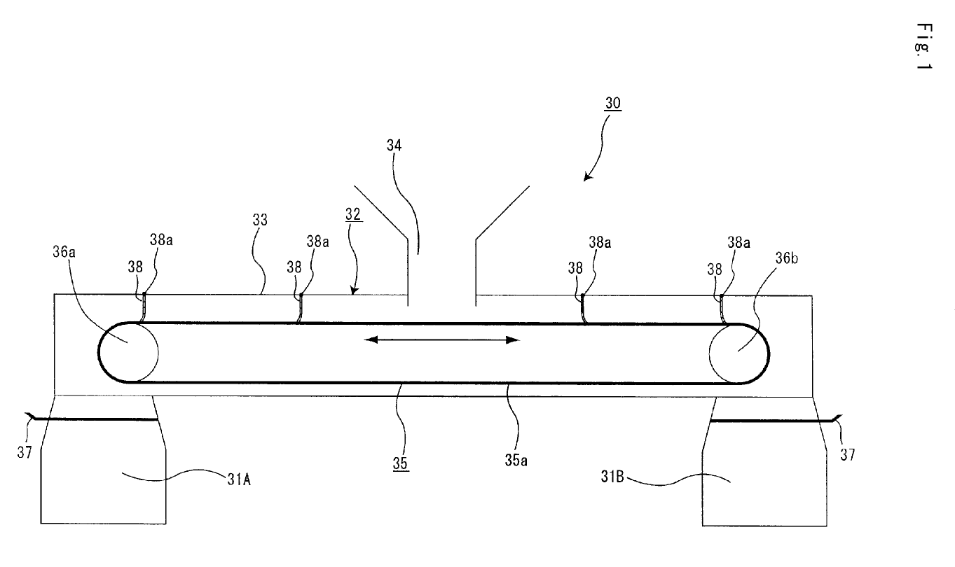

FIG. 1 is a cross-sectional view schematically showing an example of the conveyer apparatus according to one embodiment of the present invention.

This conveyer apparatus 30 includes a conveyer portion 32 configured to convey wet mixture. The conveyer portion 32 includes a casing 33 having a charging port 34 for the purpose of charging a wet mixture, and a belt conveyer 35.

In the conveyer apparatus 30, when a wet mixture prepared in a wet mixing apparatus (not shown) is charged into the conveyer portion 32 from the charging port 34, it is deposited on the belt conveyer 35 constituting the conveyer portion 32.

The conveyer apparatus 30 is constituted in such a manner that the casing 33 entirely covers the belt conveyer 35 and its surroundings such that the entirety of the conveyer portion 32 can be hermetically enclosed. In this manner, with regard to the region between the interior and the exterior of the casing 33, it may become easier to prevent the moisture contained in the air within the casing 33 from moving out of the casing 33.

Because of this, if a prescribed amount of moisture evaporates from the wet mixture inside of the casing 33, thereby increasing the humidity level of the inside of the casing 33, it may become easier to subsequently maintain this state of a high humidity inside the casing 33.

In this manner, since the rate of evaporation of the moisture from the wet mixture inside of the casing 33 per unit time tends to decrease by charging the wet mixture into the casing 33 while incessantly maintaining the state of high humidity inside of the casing 33, it may become easier to decrease the amount of the moisture evaporating inside of the casing 33, and therefore to prevent the drying of the wet mixture.

Due to the above mentioned operation, since it may become easier to prevent drying of the wet mixture from occurring inside of the conveyer portion 32, it may become easier to conduct conveyance in such a manner that the percentage of change in moisture content of the wet mixture between before and after conveyance is kept to about 3% or less.

Also, it is preferable that the percentage of change in moisture content of the wet mixture between before and after conveyance is lower, more preferably as close to 0% as possible.

As shown in FIG. 1, it is preferable for the conveyer portion 32 to be formed by the casing 33 and the belt conveyer 35 disposed inside of the casing 33.

Incidentally, in the conveyer apparatus 30 according to the embodiment of the present invention, the ‘casing 33’ includes a casing having a box-shaped member with a lid disposed thereon, and a casing pre-formed as a tube-shaped member.

Also, it is preferable that the casing 33 be made of a material having a low water permeability. With a material having a low water permeability, it may become easier to prevent moisture from moving between the interior and the exterior of the casing 33. Specifically, it is preferable that the material is a metal, and the kind of metal is not particularly limited.

Also, it is acceptable to dispose a partition member 38 configured to partition off the interior of the casing 33 near the end portion of the downstream side of the belt conveyer 35. A top end of this partition member 38 is installed on a shaft 38a disposed on the face of the top plate of the casing 33 so that the partition member 38 is able to rotate over a prescribed angle around the shaft 38a as a center.

This partition member 38 partitions off the interior of the casing 33, and prevents the moisture from moving between partitioned spaces. With this, it may become easier to even more narrowly partition off the space in which the wet mixture exists and thus to hold the humidity level of the partitioned space high.

By holding the humidity level of the space in which the wet mixture exists high, it may become easier to reduce the amount of moisture evaporating from the wet mixture, and therefore even further to reduce the percentage of change in moisture content of the wet mixture between before and after conveyance.

Also, since the top end of the partition member 38 is installed on a shaft 38a disposed on a face of the top plate of the casing 33 so that the partition member 38 is able to rotate over a prescribed angle around the shaft 38a as a center, when force is applied to the front end of the partition member 38 by the wet mixture moving on a belt 35a, the partition member 38 rotates slightly around the shaft 38a in the direction of movement of the belt 35a, thereby making it possible to convey the wet mixture in a state in which the end portion of the partition member 38 is in contact with the surface of the wet mixture.

If the end portion of the partition member 38 is in the state of contacting the surface of the wet mixture, since the movement of the moisture between partitioned spaces tends not to occur, it may become easier to reduce the amount of moisture evaporating from the wet mixture while it is conveyed.

Also, although the material of the partition member 38 is not particularly limited, it is preferable that it be a material having low moisture permeability and low water absorption properties. This is because, with a material having a low moisture permeability property, it may become easier to prevent the movement of moisture between the partitioned spaces. Also, with a material having a low water absorption property, since the moisture contained in the wet mixture tends not to be absorbed by the partition member 38, and therefore the moisture content of the wet mixture tends not to decrease.

Specifically, resin materials having a low water absorption property such as fluorine resin, or metal materials are preferable.

Although the thickness of the partition member 38 is not particularly limited, it is preferable to adjust the thickness, in consideration of the relationship with the water permeability of the partition member 38, to such an extent that moisture tends not to permeate the partition member 38. Also, it is preferable that the partition member 38 be made of a material having bendability. This is because when force is applied to the partition member 38 by the wet mixture moving on the belt 35a, the front end of the partition member 38 can bend and tends not to become a hindrance to the movement of the wet mixture, and therefore it may become easier to conduct conveyance in a state in which the partition member 38 is in contact with the surface of the wet mixture.

Also, it is acceptable to dispose a plurality of the partition members 38 over the conveyance path of the wet mixture. By disposing a plurality of the partition members 38, it may become easier to even more narrowly partition off spaces in which the wet mixture exists, and therefore to prevent drying of the wet mixture within the partitioned spaces.

The belt conveyer 35 includes a belt 35a, and rollers 36a, 36b, and conveys the wet mixture (not shown) deposited on the belt conveyer 35 in the direction of the downstream side of the belt conveyer 35 in a continuous or intermittent manner.

The material of the belt 35a is not particularly limited. Examples of the material of the belt 35a include resins such as rubber, urethane, vinyl-chloride, fluorine resin, silicone resin, and the like.

Here, as shown in FIG. 1, it is acceptable to dispose storage portions 31A, 31B on the portions at the side which is to be the downstream side when the belt conveyer 35 is in motion.

In the conveyer apparatus 30 shown in FIG. 1, since the downstream side location changes depending on the direction of rotation of the belt conveyer 35, the storage portion 31A and storage portion 31B are disposed on both end sides of the belt conveyer 35.

The storage portion 31A has on its bottom face an openable and closable discharging port. The storage portion 31A tends to temporarily store a given amount of wet mixture, as well as to supply, under control, wet mixture at a constant amount per unit time from its discharging port to the apparatus of the next process, for example an extrusion molding apparatus used for manufacturing a molded body.

Also, the storage portion 31A has an open/close plate 37 slidable in the left and right directions. By setting this open/close plate 37 into a closed state (the state depicted in FIG. 1), it is possible to set the storage portion 31A apart from other regions of the conveyer apparatus 30.

In this way, it may become easier to narrowly partition off the space in which the stored wet mixture exists, and therefore to prevent the drying of the wet mixture stored within the storage portion 31A. In cases in which the conveyer apparatus 30 is not working, and the supply of the wet mixture to the storage portion 31A is suspended, setting the open/close plate 37 into a closed state is effective in the prevention of drying of the wet mixture.

Also, in the conveyer apparatus 30, by reversing the direction of rotation of the rollers 36a, 36b, it may become easier to convey the wet mixture deposited on the belt conveyer 35 to the storage portion 31B situated on the opposite side of the storage portion 31A in a continuous or intermittent manner, and therefore it may become easier to store the wet mixture in the storage portion 31B.

In the same manner as in the storage portion 31A, the storage portion 31B also has on its bottom face an openable and closable discharging port, therefore it may become easier to temporarily store a given amount of wet mixture and also to supply, under control, wet mixture at a constant amount per unit time from its discharging port to the apparatus used in the next process.

In the same manner as in the storage portion 31A, the storage portion 31B also has the open/close plate 37, and therefore it may become easier to prevent drying of the wet mixture in the storage portion 31B.

In this manner, since it is possible for the conveyer apparatus 30 to convey the wet mixture to both the storage portion 31A and the storage portion 31B thereby storing it, the conveyer portion 32 includes a distribution mechanism.

Also, in cases in which the wet mixture is distributed and supplied to two extrusion molding apparatuses, it is possible to select the amount of the wet mixture to be allocated among the apparatuses by adjusting factors such as the movement speed of the belt conveyer 35, and the running time and the like in the forward and reverse rotation directions. Also, it is acceptable to simply select how much of the wet mixture is to be sent to either storage in an appropriate manner.

In the conveyer apparatus 30, since it is possible for the storage portion 31A and the storage portion 31B to fulfill a role as a buffer, even in cases in which in the wet mixing machine (not shown), which is used preceding the conveyer apparatus 30, mixing is continuous and the wet mixture is charged into the conveyer apparatus 30 in a continuous manner while the operation of the apparatus used in the subsequent process is currently stopped, it may become easier to maintain that state just as it is if the period of time in question is relatively short.

Also, even in the opposite case in which the mixing of the wet mixing machine is currently stopped and the wet mixture is not being charged into the conveyer apparatus 30 yet it is still necessary for wet mixture to be supplied to the apparatus of the subsequent process, it is still possible to continuously supply the wet mixture to the apparatuses of the subsequent processes such as the extrusion molding apparatus and the like.

The conveyer apparatus 30 shown in FIG. 1 is a conveyer apparatus including a distribution mechanism, and the distribution mechanism is disposed on the conveyer portion 32.

However, the structure of the conveyer apparatus according to the embodiments of the present invention is not limited to this kind, as it is possible for instance to have a structure mentioned below.

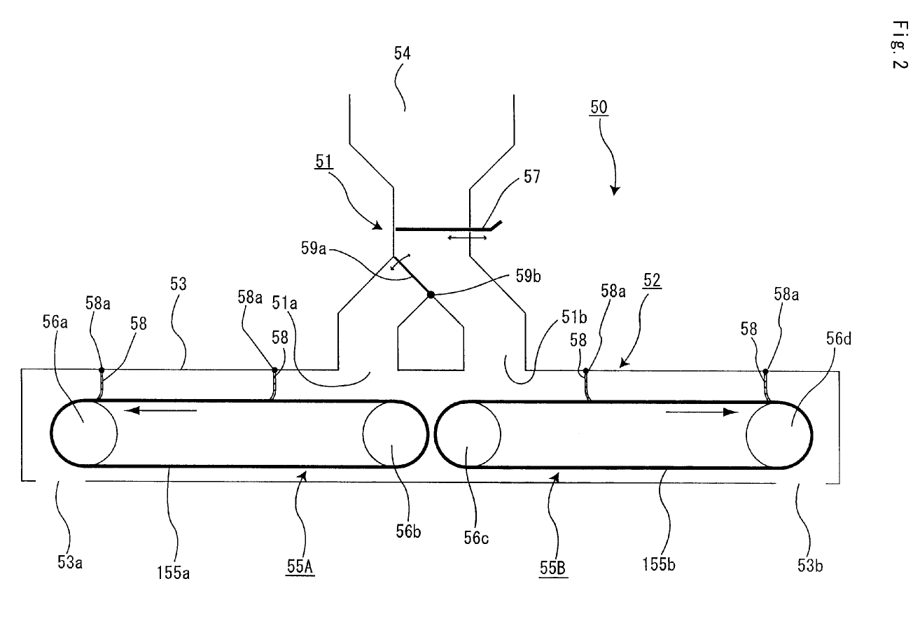

FIG. 2 is a cross-sectional view schematically showing another example of the conveyer apparatus according to one embodiment of the present invention.

Although the conveyer apparatus 50 shown in FIG. 2 is one including a conveyer portion 52 and a storage portion 51, the conveyer apparatus 50 differs from the conveyer apparatus 30 shown in FIG. 1 at the point of including the storage portion 51 in the upstream side from the conveyer portion 52 in the conveyance path of the wet mixture.

More specifically, the conveyer apparatus 50 includes the conveyer portion 52 configured to convey the wet mixture, and the storage portion 51 for temporarily storing the wet mixture. The conveyer portion 52 includes a casing 53, and belt conveyers 55A, 55B.

Discharging ports 51a, 51b disposed at the bottom face of the storage portion 51 are in communication with the top face of the casing 53, and it is possible to charge the wet mixture into the interior of the casing 53 through the discharging port 51a and the discharging port 51b.

The conveyer apparatus 50, in the same manner as in the conveyer apparatus 30 shown in FIG. 1, is constituted in a manner that the casing 53 is disposed to entirely cover the belt conveyer 55A, the belt conveyer 55B and their surroundings such that the entirety of the conveyer portion 52 can be hermetically enclosed. In this manner, since it may become easier to prevent the moisture contained in the air within the casing 53 from moving out of the casing 53 and to prevent the drying of the wet mixture in the conveyer portion 52, it may become easier to conduct conveying of the wet mixture while retaining the moisture content of the wet mixture so that the percentage of change in moisture content of the wet mixture between before and after conveyance is kept to about 3% or less.

Also, in the same manner as in the conveyer apparatus 30 shown in FIG. 1, it is acceptable to dispose a partition member 58 for partitioning the interior of the casing 53 near the end portion of the downstream side of each of the belt conveyer 55A and the belt conveyer 55B. With this, it may become easier to even more narrowly partition off the space in which the wet mixture exists and therefore to even further reduce the percentage of change in moisture content of the wet mixture within the space partitioned off.

Also, since the shape, material, and the like of the casing 53, a belt 155a, a belt 155b, the partition member 58, and a shaft 58a are identical to those in the conveyer apparatus 30 shown in FIG. 1, explanation is omitted.

In the casing 53, the belt conveyer 55A (including the belt 155a and rollers 56a, 56b), and the belt conveyer 55B (constituted by the belt 155b and rollers 56c, 56d) are disposed, and each of the belt conveyer 55A and belt conveyer 55B is constituted in such a manner that it can convey the wet mixture toward the end portion side of the casing 53.

The storage portion 51 has an open/close plate 57 slidable in the left and right directions. By setting this open/close plate 57 into a closed state (the state depicted in FIG. 2), it is possible to divide the interior space of the storage portion 51 into an upper portion and a lower portion.

The portion on the lower side of the storage portion 51 divided by the open/close plate 57 includes at its bottom face the discharging ports 51a, 51b at two places, thereby including a distribution mechanism for discharging the wet mixture from only one of the discharging ports.

More specifically, a shaft member 59b is installed at a bifurcation point between the discharging port 51a and the discharging port 51b in a manner able to rotate, and one side of a plate-shaped switch plate 59a is fixed onto this shaft member 59b. This switch plate 59a is constituted in a manner able to move over a prescribed angle according to the rotation of the shaft member 59b.

In this kind of storage portion 51, in a case in which the open/close plate 57 is closed, it is possible to store wet mixture prepared within a wet mixing machine (not shown) in the upper portion (the portion above the open/close plate 57, in FIG. 2).

Also, in a case in which the charge of the wet mixture from the wet mixing machine is currently stopped, it is effective, in the prevention of drying of the wet mixture, to dispose an open/close plate or the like at a wet mixture charging port 54 to close the charging port 54 thereby narrowly partitioning off the space in which the wet mixture exists.

Also, in cases in which the open/close plate 57 has been slid to make an open state, the wet mixture can be charged into the interior of the casing 53 through the discharging port 51a and/or the discharging port 51b. Here, by disposing the switch plate 59a in a position (refer to FIG. 2) closing the discharging port 51a, the wet mixture stored above the open/close plate 57 can be charged into the interior of the casing 53 through the discharging port 51b. Moreover, in a case in which the position of the switch plate 59a is switched so that it therefore is made to close the discharging port 51b side, the stored wet mixture can be charged into the interior of the casing 53 through the discharging port 51a.

In this case, it is possible to adjust the amount of the wet mixture to be discharged from either the discharging port 51a or the discharging port 51b by adjusting the degree of openness of the open/close plate 57.

Also, by applying vibration with a vibrator or the like, it is possible to force wet mixture to fall in a small amount at a time, and by adjusting the strength of the vibrations, it is possible to control the amount of the wet mixture discharged from either the discharging port 51a or the discharging port 51b.

Therefore, with this storage portion 51 it is possible to temporarily store the wet mixture in the portion above the open/close plate 57 by closing the open/close plate 57, distribute the wet mixture by selecting which discharging port to open (or close off) by the switch plate 59a, and therefore it may become easier to conduct charge of the wet mixture into the interior of the casing 53. More specifically, in a case in which the discharging port 51a of the storage portion 51 is opened, wet mixture is deposited on the belt 155a, and in a case in which the discharging port 51b is opened, the wet mixture is deposited on the belt 155b.

It is also acceptable to set the switch plate 59a at a position at which it closes off neither the discharging port 51a nor the discharging port 51b, thereby charging the wet mixture from both the discharging port 51a and the discharging port 51b simultaneously. In this manner, in the conveyer apparatus 50, the storage portion 51 includes a storage mechanism and a distribution mechanism.

Also, after the wet mixture deposited on each of the belt 155a and the belt 155b is conveyed in its prescribed direction by the belt conveyer 55A and the belt conveyer 55B, it is supplied to the apparatus used in the next process through a discharging port 53a and a discharging port 53b disposed on the casing 53.

Although the conveyer apparatuses according to the embodiments of the present invention explained above with reference to FIGS. 1 and 2 are conveyer apparatuses including storage portions on either the upstream side or the downstream side of the conveyer portion, it is acceptable if the conveyer apparatus according to the embodiments of the present invention does not even include a storage portion, or it includes storage portions on both the upstream and the downstream sides of the conveyer portion.

Also, although in the conveyer apparatuses according to the embodiments of the present invention shown in FIGS. 1 and 2, either the conveyer portion or the storage portion includes a distribution mechanism, it is acceptable not to include a distribution mechanism, or to alternately include distribution mechanisms at both the conveyer portion as well as the storage portion.

Also, in a case in which the conveyer apparatus according to the embodiments of the present invention includes a distribution mechanism, the distribution destinations are not limited to two sites, but can also be three or more.

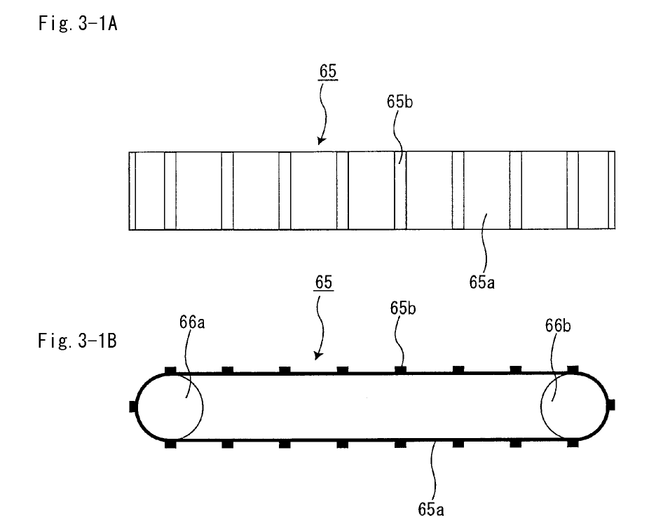

Also, although the conveyer apparatuses according to the embodiments of the present invention shown in FIGS. 1 and 2 include belt conveyers using flat-plane belts as the conveyer, the conveyer of the conveyer apparatus according to the embodiments of the present invention is not limited to this, and may be, for instance, one of the conveyers shown in FIG. 3-1A, 3-1B, 3-2A or 3-2B.

FIGS. 3-1A and 3-2A are plan views each schematically showing an alternative example of a conveyer constituting the conveyer apparatus according to one embodiment of the present invention. FIGS. 3-1B and 3-2B are cross-sectional views corresponding to FIGS. 3-1A and 3-2A, respectively.

A conveyer 65, which is shown in FIGS. 3-1A and 3-1B, includes a cleat type conveyer belt 65a and rollers 66a, 66b. Disposed on the cleat type conveyer belt 65a in a direction roughly perpendicular to the direction of movement of the belt are plate-shaped protrusions 65b. Incidentally, the conveyer portion including the conveyer 65 includes a casing, although not shown, similar to one shown in FIG. 1 or FIG. 2.

The shape of the cleat type conveyer belt 65a is not particularly limited. By disposing these cleats on the belt, it may become easier to conduct conveyance without the wet mixture flowing downward past the surrounding cleats even in cases in which there is an incline present in the conveyance path.

Also, the material of the cleat type conveyer belt 65a is not particularly limited, and may for example include resins such as rubber, urethane, vinyl-chloride, fluorine resin, silicone resin, and the like.

Also, a conveyer 75, which is shown in FIGS. 3-2A and 3-2B, is a bucket-mounted chain conveyer, and includes a bucket-mounted chain 75a, and rollers 76a, 76b. Fixed to the bucket-mounted chain 75a at regular intervals on the surface of the chain are buckets 75b for holding wet mixture. Incidentally, the conveyer portion including the conveyer 75 includes a casing, although not shown, similar to one shown in FIG. 1 or FIG. 2.

The shape of the bucket-mounted chain 75a is not particularly limited. By using a conveyer including the bucket-mounted chain 75a, it may become easier to have a conveyer having no meandering of the belt even in cases in which the conveyance path is not a straight line.

Also, the shape and material of the bucket are not particularly limited. By disposing the buckets, it may become easier to conduct conveyance of wet mixture even in cases in which there is an incline present in the conveyance path or it is necessary to convey in vertical directions.

The material of the chain 75a is not particularly limited, and may, for example, include resins such as rubber, urethane, vinyl-chloride, fluorine resin, silicone resin, as well as metal materials.

These kinds of conveyers shown in FIGS. 3-1A, 3-1B, 3-2A and 3-2B can also be used favorably in the conveyer portion constituting the conveyer apparatus according to the embodiments of the present invention.

Also, aside from the belt conveyer, it is acceptable for the conveyer apparatus according to the embodiments of the present invention to use as the conveyer constituting its conveyer portion a chain conveyer, a pallet conveyer, a trolley conveyer, a flow conveyer, a flight conveyer, a disc conveyer, a screw conveyer, or the like, for instance.

Conventionally used conveyer apparatuses were not designed with an attention to a possible change in the moisture content of the wet mixture in the conveyance.

Also, in cases in which a storage portion for storing wet mixture is disposed at a part of the conveyer apparatus, variance occurred in the period of time from the charge of the wet mixture into the conveyer apparatus to the discharge of the same wet mixture into the apparatus used in the following process.

Under these conditions, even if the wet mixtures charged into the conveyer apparatus are the ones prepared with a uniform moisture content, there has been a problem that it may be impossible to supply a wet mixture of a constant degree of quality to the apparatuses used in the subsequent processes since variance in the moisture content of the wet mixtures discharged from the conveyer apparatus may occur due to factors such as drying over time, as well as changes in temperature and humidity.

In particular, although it is necessary to supply a wet mixture having an appropriate moisture content to the extrusion molding apparatus in the manufacture of a honeycomb structure, it is easy for the moisture content to become less than the appropriate amount when such a wet mixture is used, resulting in defects such as the surface of the extrusion molded body becoming parched (i.e. the surface having a low moisture and being dry), the occurrence of cracks, the occurrence of holes or fissures on portions of cell wall, and the occurrence of the so-called ‘cell cut-off’ state in which continuous portions of cell wall are left unformed.

Alternately, if the moisture content exceeds the appropriate amount, it becomes difficult to maintain a constant shape of the molded body until the extrusion molded body is dried, giving rise to defects such as the occurrence of warpage in the honeycomb fired body.

The conveyer apparatus according to the embodiments of the present invention is a conveyer apparatus which enables a small percentage of change in moisture content of the wet mixture between before and after the conveyance and enables to supply the wet mixture with a constant quality to the apparatus used in the following process. Particularly in cases used in manufacture of a honeycomb structure, it may become easier to prevent cracks and cell cut-off from occurring in extrusion molded bodies.

Next, explanation will be given in regard to the method for manufacturing a honeycomb structure according to the embodiment of the present invention.

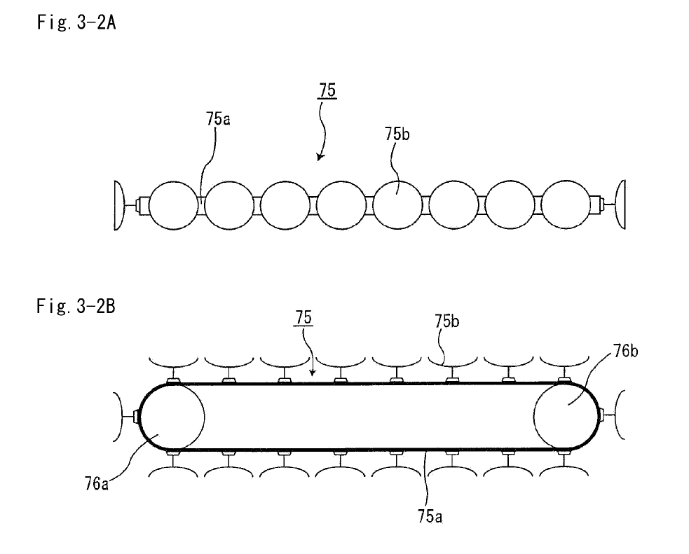

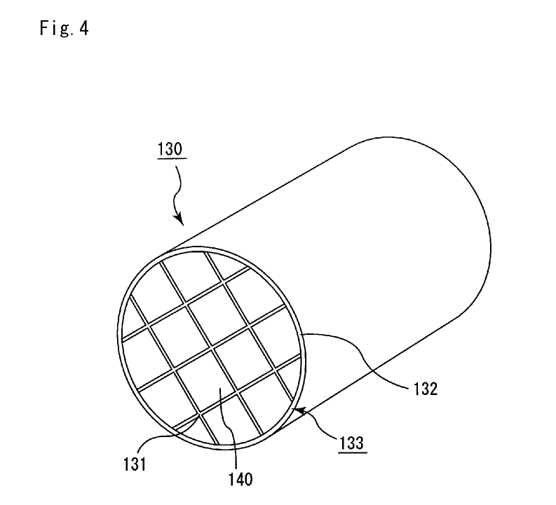

FIG. 4 is a perspective view schematically showing an example of a honeycomb structure. FIG. 5A is a perspective view schematically showing a honeycomb fired body which forms the above-mentioned honeycomb structure, and FIG. 5B is a cross-sectional view taken along a plane extending longitudinally from line A-A in FIG. 5A.

In a honeycomb structure 130, a plurality of honeycomb fired bodies 140, of the kind shown in FIG. 4, are combined with one another by interposing a sealing material layer (an adhesive layer) 131 forming a ceramic block 133, and a sealing material layer (a coat layer) 132 is formed on the periphery of the ceramic block 133.

Further, the honeycomb fired body 140 has, as shown in FIGS. 5A and 5B, a multitude of cells 141 placed in parallel in the longitudinal direction, and cell walls 143, which partition the cells 141 individually, and provide filtration functionality.

Put more plainly, as shown in FIG. 5B, the end portion of either the exhaust gas inlet side or the exhaust gas outlet side of the cells 141 formed in the honeycomb fired body 140 are sealed by a plug material layer 142. The exhaust gas which enters one cell 141 passes through the cell walls 143 dividing the cells 141 without fail, to flow out through another cell 141. When the exhaust gas passes through the cell wall 143, particulates contained within the exhaust gas are captured by the cell wall 143, thus purifying the exhaust gas.

Hereinbelow, the method for manufacturing a honeycomb structure according to the embodiments of the present invention will be described in process order.

Here, a method for manufacturing a honeycomb structure in a case wherein silicon carbide powder is used as inorganic powder, as an example of a case in which a honeycomb structure chiefly including silicon carbide as a main component is manufactured.

It is a matter of course, however, that the main component of the honeycomb structure is not limited to silicon carbide, and may be nitride ceramics such as aluminum nitride, silicon nitride, boron nitride, and titanium nitride, carbide ceramics such as zirconium carbide, titanium carbide, tantalum carbide, and tungsten carbide, oxide ceramics such as alumina, zirconia, cordierite, mullite, aluminum titanate, and the like.

Among these components, non-oxide ceramics are preferable, and silicon carbide is particularly preferable. This is because they are excellent in thermal resistance, mechanical strength, thermal conductivity and the like. Moreover, silicon-containing ceramic, which is the above-mentioned ceramic blended with metallic silicon, as well as ceramic bonded by silicon or silicate compounds can also be used as the constitutional material. Among these, silicon carbide blended with metallic silicon (silicon-containing silicon carbide) is preferable.

First, organic binder is dry mixed with an inorganic powder such as silicon carbide powder having a varying average particle diameter to prepare a powder blend. While the powder blend is being prepared, a liquid blend is prepared by blending liquid plasticizer, lubricant, and water. Next, the above mentioned powder blend and the above mentioned liquid blend are further blended together using a wet mixing machine, and thus a wet mixture for manufacturing the molded body is prepared.

Now although the particle diameter of the above mentioned silicon carbide powder is not particularly limited, the silicon carbide powder that tends not to cause the case where the size of the honeycomb structure manufactured by the following firing treatment becomes smaller than that of the honeycomb molded body after degreased is preferable, and for example, a combination of 100 parts by weight of powders having an average particle diameter of at least about 0.3 μm and at most about 50 μm, and at least about 5 parts by weight and at most about 65 parts by weight of powders having an average particle diameter of at least about 0.1 μm and at most about 1.0 μm is preferable.

Although, in order to adjust the pore diameter and the like of the honeycomb fired body, it is necessary to adjust the firing temperature, it may also become easier to adjust the pore diameter by adjusting the particle diameter of the inorganic powder.

The above-mentioned organic binder is not particularly limited, and examples thereof may include methyl cellulose, carboxymethyl cellulose, hydroxyethyl cellulose, polyethylene glycol and the like. Among these, methyl cellulose is preferable.

It is preferable that the above mentioned binder be blended with the inorganic powder at a ratio of at least about 1 part by weight and at most about 10 parts by weight of binder per 100 parts by weight of inorganic powder.

The above-mentioned plasticizer is not particularly limited, and examples thereof may include glycerin and the like.

Also, the above-mentioned lubricant is not particularly limited, and examples thereof may include polyoxyalkylene compounds such as polyoxyethylene alkyl ether, polyoxypropylene alkyl ether, and the like.

Specific examples of the lubricant may include polyoxyethylene monobutyl ether, polyoxypropylene monobutyl ether and the like.

Also, in some cases, it is unnecessary to use plasticizer or lubricant in the material powder blend.

Also, when preparing the above mentioned wet mixture, it is acceptable to use a liquid dispersing medium such as water, organic solvents such as benzene, and alcohol such as methanol.

Further, it is also acceptable to add a molding auxiliary to the above mentioned wet mixture.

The molding auxiliary is not limited in particular, and examples thereof may include ethylene glycol, dextrin, fatty acids, fatty acid soap, polyalcohol, or the like.

Further, it is acceptable to add balloons, which are micro-sized hollow spherical bodies containing oxide ceramic as component, and pore-forming agent such as a spherical acrylic particle or graphite to the above-mentioned wet mixture, if necessary.

The above-mentioned balloon is not particularly limited, and examples thereof may include alumina balloon, glass micro balloon, shirasu balloon, fly ash balloon (FA balloon), mullite balloon and the like. Among these, alumina balloon is preferable.

Also, the wet mixture prepared here using silicon carbide powder is preferably at a temperature of about 28° C. or less. If the temperature is 28° C. or less, the organic binder tends not to gelate.

Also, it is preferable that the proportion of organic component within the above mentioned wet mixture be about 10% by weight or less.

The above mentioned wet mixture is conveyed after preparation and supplied to a molding apparatus.

In the method for manufacturing a honeycomb structure according to the embodiment of the present invention, a conveyer apparatus capable of keeping the percentage of change in moisture content of the wet mixture between before and after conveyance to about 3% or less is used.

Specifically, it is possible to use the conveyer apparatus according to the embodiments of the present invention already described hereinabove.

Here, an explanation is given concerning a desirable moisture content within the wet mixture in the method for manufacturing a honeycomb structure according to the embodiments of the present invention when water is used as a liquid dispersing medium. The desirable value of the moisture content within the wet mixture is as follows: the desirable lower limit is about 10% by weight, and more desirably about 12% by weight. The desirable upper limit is about 20% by weight, and more desirably about 15% by weight. If the moisture content is about 10% by weight or more, cracks, cell cut-off and the like tend not to easily occur in the molded body. On the other hand, if the moisture content is about 20% by weight or less, it may not become difficult for the extrusion molded body to maintain a constant shape until it is dried.

For this reason, it is necessary to control the moisture content of the wet mixture within the above mentioned range.

Here, the extrusion molding using the extrusion molding apparatus mentioned hereinafter first sets various conditions such as the molding force, molding speed, and the like optimized in accordance with the theoretical moisture content value obtained when mixing the wet mixture supplied to the extrusion molding apparatus, and then conducts extrusion molding with those set condition.

Because of this, even if the actual measured value of the moisture content of the wet mixture supplied to the extrusion molding apparatus is within the above mentioned range (at least about 10% by weight and at most about 20% by weight), the extrusion molding conditions are not suitable to attain a molded body of a constant level of quality if the divergence of the theoretical value of the above mentioned moisture content with the actual measured value is great, cracks, cell cut-off and the like may occur in the molded body, or possibly the extrusion molded body cannot maintain a constant shape until it is dried.

In particular, in the extrusion molding in the method for manufacturing a honeycomb structure according to the embodiments of the present invention, it is desirable to use a wet mixture with a moisture content of at least about 10% by weight and at most about 20% by weight and with the difference of the actual measured value and the above mentioned theoretical value of the above mentioned moisture content within about ±3%. This is because in a case in which extrusion molding is conducted with a wet mixture having a moisture content within the above mentioned range and conducted under the extrusion molding conditions set optimally for the moisture content, inconveniences such as cracks, cell cut-off and the like in the molded body tend not to occur, or inconveniences wherein the molded body cannot maintain a constant shape tend not to occur easily.

In the method for manufacturing a honeycomb structure according to the embodiments of the present invention, since conveyance is conducted using the conveyer apparatus according to the embodiments of the present invention described hereinabove, it may become easier to keep the amount of moisture evaporation occurring within the casing small and therefore to prevent drying of the wet mixture. Because of this, it may become easier to conduct conveyance in such a manner that the percentage of change in moisture content of the wet mixture between before and after conveyance is kept to as low as about 3% or less. Also, in cases of using a conveyer apparatus having a partition member, it may become easier to further reduce the amount of moisture evaporating from the wet mixture, and therefore it may become easier to even further reduce the percentage of change in moisture content of the wet mixture between before and after conveyance. Because of this, it may become easier to convey a wet mixture while maintaining a suitable moisture content and to supply this wet mixture to the extrusion molding apparatus in a stable manner.

Also, in a case of using the above mentioned conveyer apparatus according to the embodiments of the present invention having a storage portion, it may of course become easier to conduct conveyance of a wet mixture to the extrusion molding apparatus used in the next process in such a manner that the wet mixture maintains a suitable moisture content. In addition, in the next process and the subsequent processes (set forth hereinbelow), even if a trouble arises and the production line is stopped, it may become easier to temporarily store the wet mixture in the storage portion, it may become easier to keep preparing wet mixture in operation without stopping.

Also, it is preferable that the conveyer apparatus according to the embodiments of the present invention used here be able to store inside of the storage portion the wet mixture at least about 1.5 times and at most about 3 times (weight conversion) as much as the molding capability of the extrusion molding apparatus.

Also, in the method for manufacturing a honeycomb structure according to the embodiments of the present invention, when conveying the prepared wet mixture, it is desirable to store the above mentioned wet mixture in the above mentioned storage portion for a given period of time. This is because the moldability of the wet mixture tends to be improved in the subsequent extrusion molding.

The reason for this is not clear, but it is thought to lie in that when the above mentioned wet mixture is thus stored, it is cooled and aged, and during this time of cooling and aging, the organic binder undergoes swelling and the lubricative properties of the inorganic powder (silicon carbide powder) tends to improve.

In a case of storing the above mentioned wet mixture for a given period of time, although the storage time period is not particularly limited, it is desirable that the lower limit be about 1 hour, and is even more desirable if the lower limit is about 4 hours. It is desirable that the upper limit of the storage time period be about 10 hours, and is even more desirable if the upper limit is about 8 hours.

This is because, if the storage time period is about 1 hour or more, there will be improvement in the moldability of the wet mixture, and if the storage time period is about 10 hours or less, portions of the wet mixture tend not to be dried and the moldability of the wet mixture tends not to be degraded.

In a case in which the moldability of the wet mixture has improved, it may become easier to lessen the molding force used during extrusion molding, and by lessening the molding force, it may become easier to reduce the occurrence rate of molding defects, and further it may become easier to lengthen the lifespan of the wear-out components (die and the like) constituting the extrusion molding apparatus.

When storing the wet mixture as mentioned above, it is desirable to dispose an openable and closable open/close plate at the storage portion of the conveyer apparatus and close the open/close plate during storage thereby sealing off the storage portion. This is because, by narrowly partitioning off the space in which the stored wet mixture exists, it may become easier to prevent drying of the wet mixture stored within the storage portion and therefore to supply a wet mixture having a suitable moisture content to the apparatus used in the extrusion molding thereafter.

Next, the extrusion molding is carried out.

Although the extrusion molding apparatus used in the extrusion molding in the method for manufacturing a honeycomb structure according to the embodiments of the present invention is not particularly limited, explanation will be given hereinbelow concerning an example of an extrusion molding apparatus and an extrusion molding method using the same with reference to the figures.

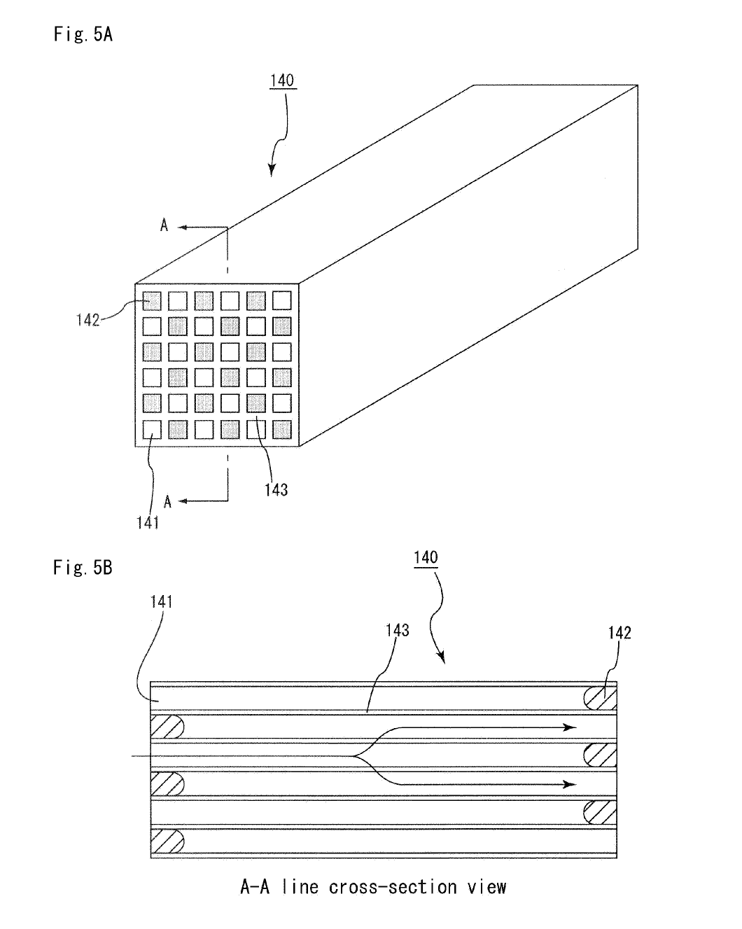

FIG. 6 is a side view schematically showing an example of the extrusion molding apparatus used in the extrusion molding.

This extrusion molding apparatus 220 includes two screw mixers including an upper tier screw mixer 241 and a lower tier screw mixer 261. A screw including an agitation shaft (screw shaft) and an agitation blade (screw blade) is disposed in each the upper tier screw mixer 241 and the lower tier screw mixer 261.

Disposed on one end portion of the above mentioned upper tier screw mixer 241 is a charge hopper 231 configured to take in a pre-mixed raw material wet mixture, and disposed in a reception port 249 on the bottom of the charge hopper 231 is a knead-press 242 configured to press the wet mixture into the interior of the upper tier screw mixer 241.

The knead-press 242 presses the wet mixture that has fallen down through the charge hopper 231 in between a pair of knead-press rollers while kneading the wet mixture, and thereafter pushes the wet mixture out of the underside of the rollers by rotating inwardly, thereby supplying the wet mixture to the interior of the upper tier screw mixer 241.

The upper tier screw mixer 241 includes an upper tier screw 243 including a feed screw and a take screw disposed at the front end of the feed screw. The feed screw has a role of moving the wet mixture while kneading the same, and the take screw is configured mainly to knead the wet mixture. In the feed screw, a screw blade (agitation blade) is wrapped around a screw shaft in a spiral shape, and with this blade, the wet mixture is both kneaded and pushed out in a forward direction.

The take blade includes a plurality of screw blades formed on the screw shaft in a manner forming a ring around the circumferential direction of the screw shaft, and there is a portion that is disconnected in a slanting direction and has no screw blade. Kneading of the wet mixture proceeds further while the wet mixture passes through this portion.

Situated on the other end of the upper tier screw mixer 241 is an upper tier die (mouth-piece) having a multitude of through holes formed thereon. After passing through the take screw, the wet mixture is pressed into this upper tier die and is extruded in a state in which the wet mixture is shaped like a rod or Japanese noodle, for instance.

Disposed on the portion at which the wet mixture is extruded from the upper tier die is a decompression chamber 246, the interior of which is in a state of decompression nearing a vacuum state. The interior of the upper tier screw mixer 241 and the lower tier screw mixer 261 are also held in a state of decompression so as not to trap bubbles (air) in the wet mixture. If bubbles are trapped in the wet mixture, it becomes easy for defects caused by bubbles situated inside of the partition walls and the like to occur when manufacturing the molded body.

Also, disposed on the inside of the decompression chamber 246 and near the upper tier die is an upper tier cutter 245 used as a cutting member. More specifically, the blade of the upper tier cutter 245 is situated in the interior of the decompression chamber 246, and this blade portion is set into reciprocating motion in the up/down directions near the upper tier die by an air cylinder disposed on the decompression chamber 246, in a manner cutting the wet mixture, which has been extruded from the upper tier die in a Japanese noodle shape (or rod shape), into smaller pieces.

The multitude of cut small pieces immediately fall into a reception port 269 of the underlying lower tier screw mixer 261, and are pressed into the interior of the lower tier screw mixer 261 by a knead-press 262 (which is constituted in a manner similar to the above described knead-press 242). In this way, the mixing of the wet mixture tends to proceed further.

The lower tier screw mixer 261 includes a lower tier screw 263 including a feed screw and a W blade screw disposed on the front of the feed screw. At the front end portion the wet mixture is pressed quantitatively into a die 264.

In this manner, by repeating the action of kneading, the mixing of the wet mixture proceeds sufficiently, and the wet mixture thereby takes the form of a composite exhibiting uniformity in its moisture content, composition, and the like, and tends to be then extruded in a continuous manner from the die 264, therefore it may become easier to form a continuous rectangular pillar-shaped molded body with a plurality of cells in the longitudinal direction.

Also, in the extrusion molding apparatus 220 shown in FIG. 1, although the wet mixture is pressed into the screw mixer by the knead-press machine, it is also acceptable for the wet mixture to be pressed into the screw mixer by another device, and it is also acceptable to only form a charge hopper. Also, the assembly arrangement of the screws disposed in the interior of the screw mixer is not limited to the above described assembly arrangement. It is also acceptable, for example, to constitute the screw with feed screws only, or another assembly arrangement is acceptable.

In this extrusion molding apparatus 220, after wet mixture has entered the interior of the extrusion molding apparatus 220, it is preferable that the time period until it is extruded be at least about 50 minutes and at most about 90 minutes. This is because it may become easier to achieve a sufficient degree of mixing and to obtain an entirely uniform composition such as moisture and the like.

Also, during extrusion molding it is desirable that the speed at which the molded body is extruded be at least about 3500 mm/min and at most about 4500 mm/min. At a speed of about 3500 mm/min or more, the production efficiency tends not to drop, thus the speed is desirable. And at an extrusion speed of about 4500 mm/min or less, it may not become difficult to obtain the honeycomb molded body with the designed dimensions and defects tend not to occur in the manufactured honeycomb molded body.

Regarding these molding conditions, it is necessary to set the optimum values in accordance with the theoretical value of the moisture content at the time of preparation of the wet mixture.

By supplying the wet mixture conveyed by the above mentioned conveyer apparatus to the above mentioned extrusion molding apparatus, it may become easier, by extrusion molding, to form a pillar shaped honeycomb molded body with a multitude of cells placed in parallel with one another in the longitudinal direction and partitioned by cell walls.

Next, using a drying apparatus such as a microwave drying apparatus, a hot air drying apparatus, a dielectric drying apparatus, a reduced pressure drying apparatus, a vacuum drying apparatus, or a freeze drying apparatus, the above mentioned honeycomb molded body is dried out.

Then, if necessary, the end portion of the outlet side of the group of inlet cells as well as the end portion of the inlet side of the group of outlet cells are filled with a prescribed amount of plug material paste which will serve as plugs, thereby plugging the cells.

Although the above-mentioned plug material paste is not particularly limited, one which makes the porosity of the plug material manufactured in the subsequent processes at least about 30% and at most about 75% is preferable. It is possible to use, for instance, a substance identical to the above-mentioned wet mixture as the plug material paste.

Next, by degreasing (at least about 200° C. and at most about 500° C., for example) and firing (at least about 1400° C. and at most about 2300° C., for example) a honeycomb molded body under prescribed conditions, which is plugged with the above-mentioned plug material paste and dried, it is possible to manufacture a honeycomb fired body having a plurality of cells placed in parallel with one another in the longitudinal direction with a cell wall therebetween, and either end portion of each cell is plugged.

In regard to the conditions for degreasing and firing the above-mentioned honeycomb molded body, it is possible to apply conventional conditions used for manufacturing a filter which is porous ceramic.

Next, the sealing material paste which will serve as the seal layer is applied onto the side of the honeycomb fired body at a uniform thickness to form the sealing material paste layer. A successively piling up other honeycomb fired bodies on this sealing material paste layer is carried out repeatedly, thereby manufacturing an aggregate of honeycomb fired bodies with a prescribed size.

Examples of the above-mentioned sealing material paste include a material including an inorganic fiber and/or an inorganic particle in addition to an inorganic binder and an organic binder, for instance.

Examples of the above-mentioned inorganic binder include silica sol, alumina sol and the like, for instance. It is also acceptable to use the above alone or in combination. Among the above-mentioned inorganic binders, silica sol is preferable.

Examples of the above-mentioned organic binder include polyvinyl alcohol, methyl cellulose, ethyl cellulose, carboxymethyl cellulose and the like, for instance. It is also acceptable to use the above alone or in combination. Among the above-mentioned organic binders, carboxymethyl cellulose is preferable.

Examples of the above-mentioned inorganic fiber include a ceramic fiber or the like such as silica-alumina, mullite, alumina, and silica, for instance. It is also acceptable to use the above alone or in combination. Among the above-mentioned inorganic fibers, alumina fiber is preferable.

Examples of the above-mentioned inorganic particle include carbide, nitride and the like, for instance. More concrete examples include inorganic powders including silicon carbide, silicon nitride, or boron nitride. It is also acceptable to use the above alone or in combination. Among the above-mentioned inorganic particle, silicon carbide, excellent in thermal conductivity, is preferable.

Moreover, it is acceptable to add balloons, which are micro-sized hollow spherical bodies containing oxide ceramic as component, and pore-forming agent such as a spherical acrylic particle or graphite to the above-mentioned sealing material paste, if necessary.

The above-mentioned balloon is not particularly limited, and examples thereof may include alumina balloon, glass micro balloon, shirasu balloon, fly ash balloon (FA balloon), mullite balloon and the like. Among these, alumina balloon is preferable.

Next, this aggregate of honeycomb fired bodies is heated to dry and solidify the sealing material paste layer, thereby forming the sealing material layer (the adhesive layer).

Next, using a diamond cutter or the like, a cutting is carried out on the aggregate of the honeycomb fired bodies in which a plurality of honeycomb fired bodies are combined with one another by interposing the sealing material layer (the adhesive layer), thereby manufacturing a cylindrical shaped ceramic block.

Then a sealing material layer is formed on the outer periphery of the ceramic block by using the above-mentioned sealing material paste to manufacture a honeycomb structure in which the sealing material layer (coat layer) is formed on the peripheral portion of the cylindrical ceramic block including a plurality of the honeycomb fired bodies combined with one another by interposing the sealing material layer (adhesive layer).

Afterward, a catalyst is supported on the honeycomb structure if necessary. The supporting of the above-mentioned catalyst may be carried out on the honeycomb fired body before manufacturing the aggregate body.

In a case of supporting the catalyst, it is preferable to form an alumina film of a high specific surface area on the surface of the honeycomb structure, and then supply a co-catalyst or a catalyst such as platinum or the like onto the surface of this alumina film.

Examples of methods for forming the alumina film onto the surface of the above-mentioned honeycomb structure include a method of impregnating the honeycomb structure with a solution of a metallic compound containing an aluminum such as Al(NO₃)₃ and then heating, a method of impregnating the honeycomb structure with a solution containing an aluminum powder and then heating, and the like, for instance.

Examples of methods for supplying the co-catalyst to the above-mentioned alumina film include a method of impregnating the honeycomb structure with a metallic compound solution containing rare earth elements or the like such as Ce(NO₃)₃ and then heating, and the like, for instance.

Examples of methods for supplying the catalyst to the above-mentioned alumina film include a method of impregnating the honeycomb structure with a nitric acid solution of diammine dinitro platinum ([Pt(NH₃)₂(NO₂)₂]HNO₃, platinum concentration: about 4.53% by weight) and the like and then heating, and the like, for instance.

It is also acceptable to supply the catalyst by a method of supplying a catalyst to alumina particle in advance, and impregnating the honeycomb structure with a solution containing the alumina powder that has been given the catalyst, and then heating.

Also, although the honeycomb structure manufactured by the method for manufacturing a honeycomb structure according to the embodiments of the present invention described above is a honeycomb structure having a structure that a plurality of honeycomb fired bodies are combined with one another by interposing a sealing material layer (adhesive layer) (hereinafter termed ‘aggregated honeycomb structure’), the honeycomb structure manufactured by the method for manufacturing a honeycomb structure according to the embodiments of the present invention may also be a honeycomb structure in which a cylindrical ceramic block is constituted by a single honeycomb fired body (hereinafter termed ‘integral honeycomb structure’).

In a case of manufacturing such an integral honeycomb structure, the honeycomb molded body is manufactured using the same methods used in the manufacture of the aggregated honeycomb structure, except that the size of the honeycomb molded body molded by extrusion molding is larger than the size of the honeycomb molded body in the manufacture of the aggregated honeycomb structure.

Here, methods and the like of conveying and storing the wet mixture yet to be extrusion molded are identical to the method of manufacturing the above mentioned aggregated honeycomb structure, and thus the explanation will be omitted.

Next, in the same manner as in the manufacture of the aggregated honeycomb structure, the honeycomb molded body is dried using a microwave drying apparatus, a hot air drying apparatus, a dielectric drying apparatus, a reduced pressure drying apparatus, a vacuum drying apparatus, a freeze drying apparatus, or the like to form a honeycomb dried body. Then, the end portion of the outlet side of the group of inlet cells as well as the end portion of the inlet side of the group of outlet cells are filled with a prescribed amount of the plug material paste which will serve as the plugs, thereby plugging the cells.

Afterward, in the same manner as in the manufacture of the aggregated honeycomb structure, a ceramic block is manufactured by degreasing and firing, and by forming the sealing material layer (the coat layer), if necessary, the integral honeycomb structure is manufactured. It is also acceptable to support a catalyst using the methods set forth above, in the above-mentioned integral honeycomb structure.

By the method for manufacturing a honeycomb structure according to the embodiments of the present invention described hereinabove, it may become easier to supply the wet mixture having a suitable moisture content to the extrusion molding apparatus in a stable manner, and to manufacture the extrusion molded body in a state that cracks, cell cut-off and the like tend not to occur after the extrusion molding when manufacturing a honeycomb structure.

Also, in cases of manufacturing a honeycomb structure according to the above described method, although it is acceptable to carry out a single run of the manufacture with a single manufacturing line, it is, for instance, also acceptable to use a conveyer apparatus including a distribution mechanism as the conveyer apparatus according to the embodiment of the present invention and to carry out the portion of the process up until the charge of the wet mixture with a single manufacturing line, and then carry out the portion of the process from the manufacture of molded bodies using an extrusion molding apparatus with a plurality (two production lines or more) of manufacturing lines.

In such a case, the wet mixture is distributed and supplied to each manufacturing line at the proper time by the distribution mechanism equipped in the above mentioned conveyer apparatus.

### EXAMPLES

Hereinbelow, in the method for manufacturing a honeycomb structure using the conveyer apparatus according to the embodiment of the present invention, honeycomb molded bodies are manufactured by extrusion molding with an extrusion molding apparatus set with molding conditions which are optimum if the moisture content of the wet mixture supplied to the extrusion molding apparatus is 13.4% by weight. Change of the moisture content of the wet mixture after the conveyance in comparison with before the conveyance, and the value of the pressure during extrusion molding were measured, while carrying out evaluation of each of the manufactured honeycomb molded bodies as to their outward appearance (i.e. presence of a parched state in the surface, presence of cracks, presence of holes or fissures on portions of cell wall, or presence of cell cut-off) as well as any formation of warpage. Also evaluated was the correlation between the moisture content of the wet mixture before and after conveying, the percentage of change in the moisture content of the wet mixture after conveyance in comparison with before conveyance and the number of occurrences of faulty product.

Now the phrase ‘percentage of change in moisture content of the wet mixture between before and after conveyance’ is used to refer to the percentage of change in moisture content of the wet mixture obtained from the moisture content of the wet mixture at the time of charging the wet mixture into the conveyer apparatus after kneading (i.e. the moisture content of the wet mixture before it is conveyed), and the moisture content of the wet mixture immediately before the time of charging the wet mixture into the extrusion molding apparatus (i.e. the moisture content of the wet mixture after it is conveyed). Specifically, the percentage of change is obtained by the following formula (1):

Percentage of change in moisture content of the wet mixture between before and after conveyance=(the moisture content of the wet mixture after it is conveyed−the moisture content of the wet mixture before it is conveyed)/the moisture content of the wet mixture before it is conveyed. (1)

Moreover, in a case in which the wet mixture is temporarily stored by a storage portion or the like before it is charged into the extrusion molding apparatus, the storage is included in the conveyance and the percentage of change in moisture content is calculated using the moisture content of the wet mixture immediately before the time of charging the wet mixture into the extrusion molding apparatus (i.e. the moisture content of the wet mixture after it is conveyed).

The molding speed and the molding pressure for each example were set to 4000 mm/min and 5.8 MPa, respectively, as the molding conditions optimized at the time at which the moisture content of the above mentioned wet mixture is 13.4% by weight.

Also, the conveyer apparatus was situated in a room at a temperature of approximately 20° C.

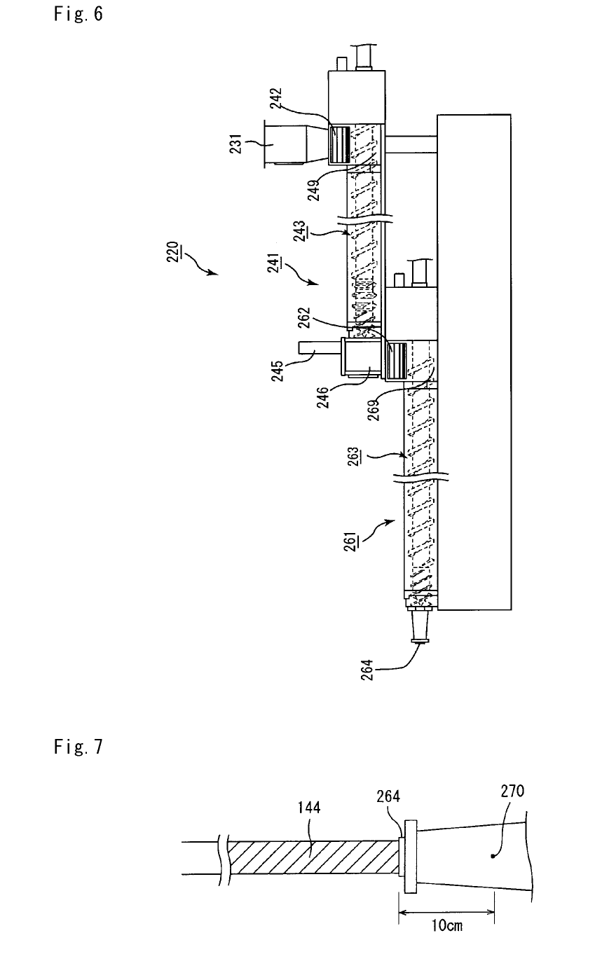

FIG. 7 is a partial cross-sectional view schematically showing an area at which the value of the pressure during molding was measured.

### Example 1

250 kg of α-type silicon carbide powder having an average particle diameter of 10 μm, 100 kg of α-type silicon carbide powder having an average particle diameter of 0.5 μm, and 20 kg of organic binder (methyl cellulose) were blended together to prepare a powder blend.

Next, 12 kg of lubricant (UNILUB, Manufactured by NOF Corp.), 5 kg of plasticizer (glycerin), and 60 kg of water were blended in a separate container to prepare a liquid mixture. Next, using a wet mixing apparatus, the powder blend and the liquid mixture were blended together, thereby preparing the wet mixture. The moisture content of the wet mixture was then measured.

Now, the moisture content of the wet mixture was measured by the halogen moisture meter HR83 manufactured by METTLER TOLEDO using approximately 2 g of the wet mixture.

Next, using the conveyer apparatus 30 according to the embodiment of the present invention shown in FIG. 1, a conveyance to convey this wet mixture to the extrusion molding apparatus 220 was carried out.

A conveyer apparatus including the casing 33 and the partition members 38 situated at four sites, as shown in FIG. 1, was used as the conveyer apparatus here.

Although the conveyer apparatus 30 in FIG. 1 includes a distribution mechanism, in the present example the wet mixture charged from the charging port 34 was conveyed via the belt conveyer 35 to the storage portion 31A without using the distribution mechanism.

Here, its structure is as follows. The horizontal distance from the charging port 34 to the storage portion 31A was approximately 5 m, and the charge hopper 231 of the extrusion molding apparatus 220 shown in FIG. 6 was connected with the bottom portion of the storage portion 31A.

Next, the wet mixture was stored inside of the storage portion 31A with the storage time period of the wet mixture of 0.5 hour or less, and then the wet mixture was supplied to the charge hopper 231 (of the extrusion molding apparatus 220) connected with and directly under the storage portion 31A.

Here, a portion of the wet mixture to be supplied to the charge hopper 231 was extracted and the moisture content of the wet mixture after conveyance was measured.

Then the measured moisture content of the wet mixture after conveyance was compared to the previously measured moisture content of the wet mixture before conveyance, and percentage of change in moisture content of the wet mixture between before and after conveyance was calculated.

Then, as described before, extrusion molding was carried out setting the molding speed and the molding pressure of the extrusion molding apparatus 220 to 4000 mm/min and 5.8 MPa, respectively, to manufacture a raw molded body 144 (refer to FIG. 7) having the same shape as the honeycomb fired body 140 (refer to FIGS. 5A and 5B).

At this time, the value of the pressure during extrusion molding is measured by disposing a pressure sensor 270 at 10 cm in front of outlet of the die 264 as shown in FIG. 7.

A stainless small pressure transducer (PGM-500KD) manufactured by KYOWA ELECTRONIC INSTRUMENTS CO., LTD. was used as the pressure sensor here.

Next, after drying the raw molded body 144 using a microwave drying apparatus or the like, prescribed cells were filled with a plug material paste of a composition identical to that of the above-mentioned wet mixture.

Next, after carrying out another drying by using a drying apparatus, degreasing was carried out at 400° C. and firing was carried out for three hours at normal pressures in an argon atmosphere at 2200° C. to manufacture a honeycomb fired body which was a silicon carbide fired body having a porosity of 40%, an average pore diameter of 12.5 μm, a size of 34.3 mm×34.3 mm×150 mm, the number of cells (cell concentration) of 46.5 pcs/cm², and a cell wall thickness of 0.25 mm.

Next, using a heat resistant sealing material paste containing 30% by weight of alumina fiber with an average fiber length of 20 μm, 21% by weight of silicon carbide powder with an average particle diameter of 0.6 μm, 15% by weight of silica sol, 5.6% by weight of carboxymethyl cellulose, and 28.4% by weight of water, a multitude of honeycomb fired bodies were adhered together, and further dried at a temperature of 120° C. Next, a cylindrical ceramic block having a 1.0 mm thick sealing material layer (adhesive layer) was manufactured by carrying out cutting using a diamond cutter.

Next, 23.3% by weight of silica-alumina fiber (average fiber length of 100 μm, average fiber diameter of 10 μm) as inorganic fiber, 30.2% by weight of silicon carbide powder with an average particle diameter of 0.3 μm as inorganic particle, 7% by weight of silica sol (SiO₂ content within the sol: 30% by weight) as inorganic binder, 0.5% by weight of carboxymethyl cellulose as organic binder, and 39.0% by weight of water were mixed and kneaded together to prepare a sealing material paste.

Next, a sealing material paste layer with a thickness of 0.2 mm was formed over the peripheral portion of the ceramic block using the above mentioned sealing material paste. This sealing material paste layer was then dried at a temperature of 120° C. to manufacture a cylindrical honeycomb structure with dimensions: 143.8 mm Diameter×150 mm Length, having a sealing material layer (coat layer) formed over the peripheral portion.

The above mentioned manufacturing was repeatedly carried out to manufacture ten samples of honeycomb structures.

A visual examination of outward appearance was then carried out regarding mainly the shape of the cells of the manufactured honeycomb molded bodies. Evaluation was made as to whether or not the desired shape was achieved with no parched state present in cell wall surface, no cracks, no holes or fissures on portions of the cell walls, or no cell cut-off. Measurement of the amount of warpage on the honeycomb molded bodies was also carried out. Then, specimens having satisfactory outward appearance with no parched state present in cell wall surface, no cracks, no holes or fissures on portions of the cell walls, and no cell cut-off, and with a warpage amount of less than 0.5 mm were evaluated as good products. The results are shown in Table 1.

The measurement of the warpage amount was carried out using a warpage amount measurement jig.

As the warpage-amount measuring jig, the following was used: a straight rectangular block which has a length of roughly the same as the full length of the molded body; contact members of identical thickness disposed on both ends of this block; and a scale, which is slidable in the direction perpendicular to the longitudinal direction of the above-mentioned block, installed at the center of this block. At the time of measurement, the above-mentioned contact members were made to contact near both ends of the molded body, a scale for measuring warpage amount was then moved toward the molded body, and the warpage amount was measured by reading the amount of movement of the scale when the above-mentioned scale contacted the molded body.

### Examples 2 to 4

Except that the time period of storing the wet mixture inside of the storage portion 31A was changed to 1, 2 and 3 hours respectively, preparation of the wet mixture, measurement of the moisture contents of the wet mixture of before and after conveyance, measurement of the value of the pressure during extrusion molding, manufacture of the honeycomb structure, and evaluation were carried out in the same manner as in Example 1. The results are shown in Table 1.

### Example 5

Except that the conveyer apparatus shown in FIG. 1, but not including partition member 38, was used, preparation of the wet mixture, measurement of the moisture contents of the wet mixture of before and after conveyance, measurement of the value of the pressure during extrusion molding, manufacture of the honeycomb structure, and evaluation were carried out in the same manner as in Example 4. The results are shown in Table 1.

### Comparative Examples 1 to 4

Except that a conveyer apparatus identical to the conveyer apparatus used in Example 1, but not including casing 33 and partition member 38, was used in the conveyance to carry out conveyance, and the time period of storing the wet mixture inside of the storage portion 31A was changed, preparation of the wet mixture, measurement of the moisture contents of the wet mixture of before and after conveyance, measurement of the value of the pressure during extrusion molding, manufacturing of the honeycomb structure, and evaluation were carried out using the same method as in Example 1. The results are shown in Table 1.

### Reference Examples 1 and 2

Except that setting the amount of water blended during preparation of the wet mixture to the amount shown in Table 1, thereby setting the moisture content of the wet mixture before conveyance to 9.9% by weight and 20.1% by weight, respectively, preparation of the wet mixture, measurement of the moisture contents of the wet mixture of before and after conveyance, measurement of the value of the pressure during extrusion molding, manufacturing of the honeycomb structure, and evaluation were carried out in the same manner as in Example 1. The results are shown in Table 1.

TABLE 1

| | | | | | | | Measurement result of moisture | | | | |
|---|---|---|---|---|---|---|---|---|---|---|---|
| | | | | | | | content after conveyance | | | | |
| | | | | | | Moisture | Moisture | | | | |
| | | | | | | content | tent | Percentage of | | | |
| | | | Amount of | | | before | after | change in moisture | Pressure | | Occur- |
| | | | materials | | Storage | conveyance | conveyance | content between | during | | rence |
| | Partition | | besides | Amount of | Time | (% by | (% by | before and after | molding | Appearance | of warp- |
| | member | Casing | water (kg) | water (kg) | (hour) | weight) | weight) | conveyance (%) | (MPa) | of defect | age |
| Ex. 1 | present | present | 387 | 59.88 | <0.5 | 13.40 | 13.37 | −0.2 | 5.8 | none | 0/10 |
| Ex. 2 | present | present | 387 | 59.88 | 1 | 13.40 | 13.31 | −0.7 | 5.8 | none | 0/10 |
| Ex. 3 | present | present | 387 | 59.88 | 2 | 13.40 | 13.15 | −1.9 | 6.1 | none | 0/10 |
| Ex. 4 | present | present | 387 | 59.88 | 3 | 13.40 | 13.06 | −2.5 | 6.1 | none | 0/10 |
| Ex. 5 | absent | present | 387 | 59.88 | 3 | 13.40 | 13.00 | −3.0 | 6.2 | none | 0/10 |
| Comp. | absent | absent | 387 | 59.88 | 1 | 13.40 | 12.97 | −3.2 | 6.7 | occurred | 0/10 |
| Ex. 1 | | | | | | | | | | | |
| Comp. | absent | absent | 387 | 59.88 | 2 | 13.40 | 12.92 | −3.6 | 6.8 | occurred | 0/10 |
| Ex. 2 | | | | | | | | | | | |
| Comp. | absent | absent | 387 | 59.88 | 3 | 13.40 | 12.81 | −4.4 | 6.8 | occurred | 0/10 |
| Ex. 3 | | | | | | | | | | | |
| Comp. | absent | absent | 387 | 59.88 | 6 | 13.40 | 12.11 | −9.6 | 7.2 | occurred | 0/10 |
| Ex. 4 | | | | | | | | | | | |
| Ref. Ex. | present | present | 387 | 42.50 | 1 | 9.90 | 9.82 | −0.8 | 7.7 | occurred | 0/10 |
| 1 | | | | | | | | | | | |
| Ref. Ex. | present | present | 387 | 97.30 | 1 | 20.20 | 20.02 | −0.9 | 3.4 | none | 10/10 |
| 2 | | | | | | | | | | | |

* Extrusion molding conditions: 4000 mm/min and 5.8 MPa
* Temperature of the room where the conveyer apparatus is placed: 20° C.

From the experiment results shown in Table 1, it is shown that in Examples 1 to 5 using the conveyer apparatus 30 according to the embodiment of the present invention, percentage of change in moisture content of the wet mixture between before and after conveyance is as extremely small as −0.2 to −3.0%, and thus it may become easier to prevent drying of the wet mixture between before and after conveyance.

Also, the value of the pressure during molding in Examples 1 to 5 neared the set value of the molding apparatus, 5.8 MPa.

Comparing these measurement results with the evaluation of the molded body product, in Examples 1 to 5 in which the percentage of change in moisture content of the wet mixture between before and after conveyance is within −3.0%, there were no occurrences of appearance defect (parched state on cell wall surfaces, cracks, holes or fissures on portions of cell wall, or cell cut-off), and no occurrences of warpage.

From this it is understood that keeping the percentage of change in moisture content of the wet mixture between before and after conveyance to about 3.0% or less provides favorable extrusion conditions, and it may become easier to prevent occurrences of appearance defect and warpage.

More specifically, by carrying out a conveyance to convey a wet mixture using the conveyer apparatus according to the embodiment of the present invention, it may become easier to prevent the occurrence of cracks, cell cut-off, and the like caused by the drying of the wet mixture.

In Comparative Examples 1 to 4, the percentage of change in moisture content of the wet mixture between before and after conveyance is as large as −3.2% to −9.6%, and the value of the pressure during molding was in the range of 6.8 to 7.2 MPa, quite higher than the set value of the molding apparatus, 5.8 MPa.

Also, in Comparative Examples 1 and 2, there was some occurrence of appearance defect in the molded body specimens, occurrence of a parched state on cell wall surfaces, cracks, and fissures on portions of cell wall, while there was no cell cut-off.

In contrast to this, in Comparative Examples 3 and 4, appearance defect occurred, namely, a parched state on cell wall surfaces, cracks, fissures on portions of cell wall, and cell cut-off.

From this it is thought that an appearance defect occurs in the following manner: first, the percentage of change in moisture content increases, that is, the moisture content of the wet mixture becomes small due to drying, and the surface of the cell wall falls into a parched state. This is thought to happen because the bond between the ceramic particles and the organic binder powder comes to weaken.

When the percentage of change in moisture content further increases, and the moisture content of the wet mixture becoming even smaller, it is thought that cracks, holes, and fissures come to form at portions of the surface that are in a parched state.

Furthermore, when the percentage of change in moisture content increases even more, the moisture content of the wet mixture becoming yet even smaller, it is thought that cell cut-off will then occur.

Also, the rise in the value of the pressure during molding is thought to happen due to dried raw material becoming difficult to be extruded, and it is thought that the occurrence of appearance defect is caused by these improper molding conditions.

From this, it is clear that such conveyances are unsuitable to be used as conveyances.

Also, as shown in Reference Example 1, in a case in which the moisture content of the wet mixture after conveyance is 10% by weight or less, although the percentage of change in moisture content of the wet mixture between before and after conveyance is small, because the moisture content of the wet mixture is small itself, the value of the pressure during molding becomes as high as 7.7 MPa and extrusion molding is thereby carried out under unsuitable extrusion conditions, which is though to be the cause of the appearance defects. From this it is understood that it is desirable for the moisture content of the wet mixture after conveyance to be about 10% by weight or more.

Moreover, as shown in Reference Example 2, in a case in which the moisture content of the wet mixture after conveyance is 20% by weight or more, although the percentage of change in moisture content of the wet mixture between before and after conveyance is small, because the moisture content of the raw molded body after conveyance is high, it becomes difficult for the raw molded body to retain a constant shape until it is dried, and thereby warpage occurs. From this it is understood that it is desirable for the moisture content of the wet mixture after conveyance to be about 20% by weight or less.

Also, if the value of the pressure during molding becomes high, this will make the die easily prone to ablation thereby degrading its durability. In consideration of the durability of the die, it is desirable that molding be carried out at a pressure value close to the set value of the molding apparatus.

It should be noted that the exemplary embodiments depicted and described herein set forth the preferred embodiments of the present invention, and are not meant to limit the scope of the claims hereto in any way. Numerous modifications and variations of the present invention are possible in light of the above teachings. It is therefore to be understood that, within the scope of the appended claims, the invention may be practiced otherwise than as specifically described herein.

What is claimed as new and desired to be secured by Letters Patent of the United States is:

1. A conveyer apparatus comprising:
a conveyer portion having disposed therein a conveyer configured to convey a wet mixture;
wherein said conveyer portion is configured to convey the wet mixture such that a percentage of change in moisture content of the wet mixture from before conveyance of the wet mixture by said conveyer to after conveyance is about 3% or less.

2. The conveyer apparatus according to claim 1, further comprising:
a storage portion configured to temporarily store the wet mixture.

3. The conveyer apparatus according to claim 2,
wherein said storage portion has an openable and closable discharging port on a bottom face of said storage portion.

4. The conveyer apparatus according to claim 2,
wherein said storage portion is disposed upstream from said conveyer portion in a conveyance path of the wet mixture.

5. The conveyer apparatus according to claim 1, further comprising:
a first storage portion configured to temporarily store the wet mixture; and
a second storage portion configured to temporarily store the wet mixture,
wherein said first storage portion and said second storage portion are disposed at opposite end sides of said conveyer.

6. The conveyer apparatus according to claim 5,
wherein said conveyer is configured to change a conveyance direction of the wet mixture deposited thereon, and
wherein said conveyer is configured to deliver the wet mixture to one of said first storage portion or said second storage portion in a continuous or intermittent manner by changing the conveyance direction.

7. The conveyer apparatus according to claim 1, wherein said conveyer portion comprises:
a casing; and
a belt conveyer disposed inside of said casing.

8. The conveyer apparatus according to claim 7,
wherein a partition member configured to partition off an interior of said casing is disposed near an end portion of a downstream side of said belt conveyer.

9. The conveyer apparatus according to claim 7,
wherein said belt conveyer comprises a belt and rollers.

10. The conveyer apparatus according to claim 9, further comprising:
a first storage portion configured to store the wet mixture; and
a second storage portion configured to store the wet mixture,
wherein said first storage portion and said second storage portion are disposed at opposite end sides of said conveyer, and
wherein said belt conveyer is configured to deliver the wet mixture to one of said first storage portion and said second storage portion in a continuous or intermittent manner by a forward rotation or reverse rotation of said rollers.

11. The conveyer apparatus according to claim 1,
wherein said conveyer is any of a chain conveyer, a pallet conveyer, a trolley conveyer, a flow conveyer, a flight conveyer, a disc conveyer, and a screw conveyer.

12. A method for manufacturing a honeycomb structure comprising a honeycomb fired body, said method comprising:
carrying out a conveyance for conveying a wet mixture containing wet mixed inorganic powders to an extrusion molding apparatus;
preparing, by extrusion molding, a pillar-shaped honeycomb molded body with a multiplicity of cells placed in parallel with one another in a longitudinal direction with a cell wall therebetween; and
firing the honeycomb molded body,
wherein, during the carrying out of the conveyance, the wet mixture is conveyed by a conveyer apparatus including a conveyer portion having disposed therein a conveyer configured to convey the wet mixture, wherein the conveyer portion is configured to convey the wet mixture such that a percentage of change in moisture content of the wet mixture from before the conveyance to after the conveyance is about 3% or less.

13. The method for manufacturing a honeycomb structure according to claim 12, wherein, prior to the preparing of the honeycomb molded body, the wet mixture is temporarily stored in a storage portion of the conveyer apparatus.

14. The method for manufacturing a honeycomb structure according to claim 13,
wherein the storage portion stores at least about 1.5 times and at most about 3 times by weight of the wet mixture as a molding capability of the extrusion molding apparatus.

15. The method for manufacturing a honeycomb structure according to claim 13,
wherein the wet mixture is temporarily stored in the storage portion for a time period of at least about 1 hour and at most about 10 hours.

16. The method for manufacturing a honeycomb structure according to claim 13,
wherein the conveyer apparatus includes a first storage portion and a second storage portion, and
wherein the first storage portion and the second storage portion are disposed at opposite end sides of the conveyer.

17. The method for manufacturing a honeycomb structure according to claim 16,
wherein the wet mixture deposited on the conveyer is stored by being conveyed to one of the first storage portion and the second storage portion in a continuous or intermittent manner by changing a conveyance direction of the conveyer.

18. The method for manufacturing a honeycomb structure according to claim 13,
wherein the storage portion has an openable and closable discharging port on a bottom face of the storage portion.

19. The method for manufacturing a honeycomb structure according to claim 13,
wherein the storage portion is disposed upstream of the conveyer portion in a conveyance path of the wet mixture.

20. The method for manufacturing a honeycomb structure according to claim 12, wherein the conveyer portion comprises:
a casing; and
a belt conveyer disposed inside of the casing.

21. The method for manufacturing a honeycomb structure according to claim 20,
wherein a partition member configured to partition off an interior of the casing is disposed near an end portion of a downstream side of the belt conveyer.

22. The method for manufacturing a honeycomb structure according to claim 20,
wherein the conveyer apparatus includes a first storage portion and a second storage portion,
wherein the first storage portion and the second storage portion are disposed at opposite end sides of the belt conveyer, and
wherein the wet mixture deposited on the belt conveyer is stored by being conveyed to one of the first storage portion and the second storage portion in a continuous or intermittent manner by a forward rotation or reverse rotation of the rollers.

23. The method for manufacturing a honeycomb structure according to claim 12,
wherein the moisture content of the wet mixture is at least about 10% by weight and at most about 20% by weight after conveyance.

24. The method for manufacturing a honeycomb structure according to claim 12,
wherein the honeycomb structure is formed by a plurality of honeycomb fired bodies combined with one another by interposing a sealing material layer.

25. The method for manufacturing a honeycomb structure according to claim 12,
wherein the honeycomb structure is formed by a single honeycomb fired body.
